(19) United States
(12) Patent Application Publication
(10) Pub. No.: US 2016/0373893 A1
(43) Pub. Date: Dec. 22, 2016

(54) IBEACON COMPATIBLE BLUETOOTH LOW ENERGY DEVICE MONITORING SYSTEM

(71) Applicant: Bleon LLC, Nashville, TN (US)

(72) Inventors: Gaurav Khanna, San Jose, CA (US); Jon Paul Stirling, Hermitage, TN (US); Joshua Thomas Reeder, Hermitage, TN (US)

(21) Appl. No.: 15/187,678

(22) Filed: Jun. 20, 2016

Related U.S. Application Data
(60) Provisional application No. 62/182,298, filed on Jun. 19, 2015.
(60) Provisional application No. 62/182,304, filed on Jun. 19, 2015.

(51) Int. Cl. H04W 4/02; H04W 4/06; H04W 4/00

(52) U.S. Cl. CPC H04W 4/021; H04W 4/008; H04W 4/025; H04W 4/06

(57) ABSTRACT

An iBeacon compatible Bluetooth low energy device based system for monitoring objects includes a plurality of devices, a plurality of managers, and a manufacturer. Devices are attached to objects or integrated into the objects. The devices may be used for positional tracking only, or may include one or more sensors for measuring or monitoring a characteristic of the object. A device manufacturer commissions the devices with unique majors and minors. Each device is then associated with a device manager, and the device transmits messages to the manager when the device is within range of the manager. The manager determines characteristics of the object as a function of the received messages and a location (e.g., GPS coordinates) of the manager.

### CROSS-REFERENCES TO RELATED APPLICATIONS

This application claims priority to and hereby incorporates by reference in its entirety U.S. Provisional Patent Application No. 62/182,298 entitled “COMMUNICATIONS PROTOCOL FOR DEVICE TRACKING SYSTEM” filed on Jun. 19, 2015 and U.S. Provisional Patent Application No. 62/182,304 entitled “DEVICE TRACKING SYSTEM” filed on Jun. 19, 2015.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to systems and method of tracking objects. More particularly, this invention pertains to wireless devices for monitoring and tracking objects.

Systems for wirelessly monitoring objects include Global Positioning System (GPS) trackers or radio frequency identification (RFID) tags. GPS trackers use large amounts of energy. GPS tracking systems therefore require large batteries and a constant or renewable power source. Additionally, these systems require wireless phone service or an IEEE 802.11 (i.e., WiFi) network in proximity in order to report tracker positions and sensed data to a device manager. RFID based systems do not require external power to monitor an object. A battery in an RFID tag including a sensor can last for years. However, data on devices tracked by RFID tags can only be retrieved by use of a specialized reader. The specialized reader must be brought into proximity with the RFID tag and then have a wireless phone service or a WiFi network through which to report data to a device manager. That is, you must find an object being tracked with an RFID tag before you can read the RFID tag to monitor or track the object.

iBeacon devices address some shortcomings of the GPS and RFID systems by providing long battery life while actively broadcasting data across substantial distances (e.g., approximately 30 feet). Thus a user does not have to find an object before they can track the object. However, iBeacon devices only broadcast a single universally unique identifier (UUID), a major, and a minor. These characteristics uniquely identify each device. The iBeacon protocol does not allow for any other data in the message broadcast (i.e., transmitted via Bluetooth low energy protocol) by the device. Thus, current iBeacon devices and readers are not compatible with sensors and cannot monitor objects. iBeacon readers receive iBeacon messages, query a database for information based on the received message (i.e., the UUID of the device) and receive information from the database as a function of the UUID of the device. Using majors and minors, some systems provide the reader with improved location data by providing more exact positional data from the database to the reader based on the major and minor. For example, the UUID of an iBeacon device may cause the database to supply the location “Smithsonian Museum of Air and Space” to the reader providing the UUID, but the major and minor will cause the database to provide the reader with a location that they are in the west wing of the third floor because the database knows the iBeacon with that UUID, major, and minor to be in the third floor west wing of the Smithsonian Air and Space Museum.

### BRIEF SUMMARY OF THE INVENTION

Aspects of the present invention provide an iBeacon compatible Bluetooth low energy device based system for monitoring objects. Devices are attached to objects or integrated into the objects. The devices may be used for positional tracking only, or may include one or more sensors for measuring or monitoring a characteristic of the object. A device manufacturer commissions the devices with unique majors and minors. Each device is then associated with a device manager, and the device transmits messages to the manager when the device is within range of the manager. The manager determines characteristics of the object as a function of the received messages and a location (e.g., GPS coordinates) of the manager.

In one aspect, a system includes an iBeacon compatible Bluetooth low energy device, and an iBeacon compatible Bluetooth low energy device manager. The iBeacon compatible Bluetooth low energy device is configured to periodically broadcast a message consisting of a Unique User identification (UUID), a major, and a minor. The iBeacon compatible Bluetooth low energy device manager is configured to receive the broadcast message from the device. The device is further configured to periodically broadcast the first message consisting of a first UUID, the major, and the minor or a second message consisting of a second UUID, the major, and the minor as a function of a parameter determined by the device. The first UUID is different than the second UUID.

In another aspect, the system comprises an iBeacon compatible Bluetooth low energy device. The iBeacon compatible Bluetooth low energy device is configured to broadcast a message consisting of a UUID, a major, and a minor. The device is further configured to periodically broadcast the first message consisting of a first UUID, the major, and the minor or a second message consisting of a second UUID, the major, and the minor as a function of a parameter determined by the device. The first UUID is different than the second UUID.

In another aspect, a system comprises an iBeacon compatible Bluetooth low energy device, an iBeacon compatible Bluetooth low energy device manufacturer, and an iBeacon compatible Bluetooth low energy device manager. The iBeacon compatible Bluetooth low energy device is configured to store a device identifier, transaction identifier, and an encryption key. The device is further configured to respond to a poll by transmitting the stored transaction identifier. The iBeacon compatible Bluetooth low energy device manufacturer is configured to provide the device with the device identifier, the transaction identifier, and the encryption key. The iBeacon compatible Bluetooth low energy device manager is configured to hold the device for the transaction identifier stored in the device, receive the transaction identifier transmitted by the device in response to polling, receive the encryption key for the device from the manufacturer, generated command string including the device identifier stored in the device, transaction identifier received from the device, and a command. The device manager is further configured to encrypt the command string as a function of the encryption key received from the manager to generate an encrypted command, and transmit the encrypted command to the device. The device is further configured to receive encrypted command transmitted by the manager, decrypt the received encrypted command with the encryption key stored in the device to determine the command string, verify that the device identifier and transaction identifier in the determined command string match the device identifier and transaction identifier stored in the device, and execute the command in the determined command string when the device identifier and transaction identifier in the determined command string match the device identifier and transaction identifier stored in the device.

In another aspect, an iBeacon compatible Bluetooth low energy device includes a memory, a processor, and a transceiver. The iBeacon compatible Bluetooth low energy device is configured to store a device identifier received from an iBeacon compatible Bluetooth low energy device manufacturer in the memory, store a transaction identifier received from the iBeacon compatible Bluetooth low energy device manufacturer in the memory, store encryption key received from the iBeacon compatible Bluetooth low energy device manufacturer in the memory, transmit, via the receiver, the transaction identifier stored in the memory in response to receiving a poll request from an iBeacon compatible Bluetooth low energy device manager, receive, via the transceiver, an encrypted command transmitted by the manager, decrypt the received encrypted command with the encryption key stored in the memory to determine a command string. The device is further configured to verify that a device identifier and a transaction identifier in the determined command string match the device identifier in the transaction identifier stored in the memory of the device, and execute the command in the determined command string when the device identifier and transaction identifier in the determined command string match the device identifier and transaction identifier stored in the memory of the device.

In another aspect, a system includes an iBeacon compatible Bluetooth low energy device and an iBeacon compatible Bluetooth low energy device manager. The device is configured to periodically broadcast a message at a first period. The iBeacon compatible Bluetooth low energy device manager is configured to determine the location of the manager, store a geographic safe zone, and determine whether the manager is in the geographic safe zone as a function of the determined location of the manager and store geographic safe zone, determine that the device is within range of the manager in response to receiving the message periodically broadcast by the device, determine that the devices within the geographic safe zone in response to determining that the managers in the geographic safe zone while the device is determined to be within range of the manager, and, in response to determining that the device and manager are in the geographic safe zone, increasing the period of the broadcast message to a second period such that the messages broadcast less frequently.

In another aspect, a system includes an iBeacon compatible Bluetooth low energy device and an iBeacon compatible Bluetooth low energy device manager. The device is configured to periodically broadcast a message at a first period. The manager is configured to determine a location of the manager; determine that the device is within range of the manager in response to receiving the message periodically broadcast by the device; store a temporary zone when the location of the manager remains within a radius of a central point longer than a first threshold with the device in range of the manager, said temporary zone being the area within the radius of the central point; determining whether the location of the manager is in the temporary zone; and in response to determining that the location of the manager is in the temporary zone and the device is in range, increasing the period of the broadcast message to a second period such that the message is broadcast less frequently.

In another aspect, a system includes an iBeacon compatible Bluetooth low energy device, a plurality of iBeacon compatible Bluetooth low energy device managers, and an iBeacon compatible Bluetooth low energy device manufacturer. The device is configured to periodically broadcast a message comprising a major and a minor stored in a memory of the device. Each manager of the plurality of managers is configured to receive the broadcast message from the device. The device is associated with one manager of the plurality of managers. The manager is configured to determine when the device is lost and report the lost device by providing the major and the minor of the lost device. The manufacturer is configured to receive the report of the lost device from the manager associated with the loss device and transmit the major and the minor of the loss device to the plurality of managers. Each manager of the plurality of managers is further configured to receive the message broadcast by the loss device and report a location of the manager together with the major and minor to the manufacturer. The manufacturer is further configured to notify the manager associated with the loss device of the location of the manager reporting the location of the manager together with the major and the minor to the manager associated with the loss device.

### BRIEF DESCRIPTION OF THE SEVERAL VIEWS OF THE DRAWINGS

FIG. 1 is a block diagram of an iBeacon compatible Bluetooth low energy device monitoring system.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The term “circuit” means at least either a single component or a multiplicity of components, either active and/or passive, that are coupled together to provide a desired function.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

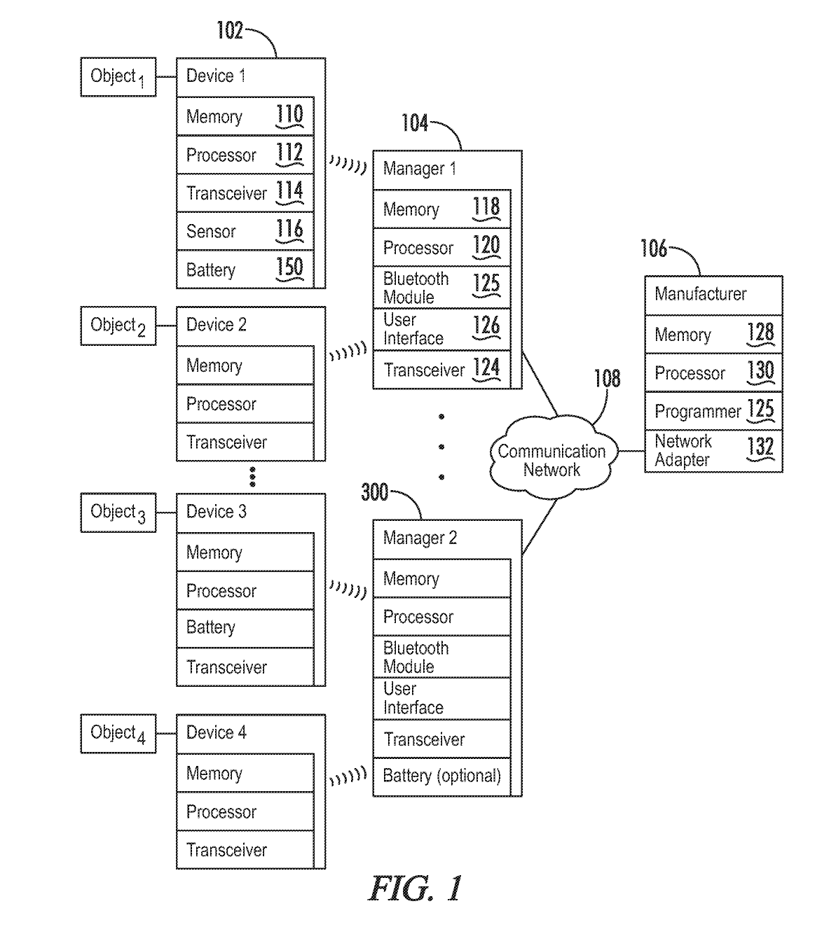

Referring to FIG. 1, a system 100 for monitoring an object (not shown) includes an iBeacon compatible Bluetooth low energy device 102, a device manager 104, and a device manufacturer 106. In one embodiment, the system 100 may include a plurality of managers, each with a plurality of devices associated therewith, and the manufacturer 106 which commissions the devices and communicates with the managers. Each device 102 includes a memory 110, a processor 112, and a transceiver 114. Sensor 116 and battery 150 are optional. The sensor 116 may be a temperature sensor, a humidity sensor, a pressure sensor, an accelerometer, an inclinometer, or any other type of sensor for sensing a characteristic of an object to which the device 102 is physically associated (i.e., attached, affixed, or integrated). The transceiver 114 is a Bluetooth low energy transceiver.

Each device manager 103 includes a memory 118, a processor 120, a user interface 126, a Bluetooth low energy communications module 125, and a transceiver 124. The transceiver 124 of the manager 103 includes either a wireless telephone transceiver, a WiFi transceiver, or both for communicating with the manufacturer 106 via a communications network 108 (e.g., the Internet).

The manufacturer 106 includes a memory 128, a processor 130, a programmer 134, and a network adapter 132. The network adapter 132 is configured to communicate with the manager 104 via the communications network 108. It is contemplated that the devices (i.e., device 102) may be physically built or assembled in whole or in part by parties other than the party operating the manufacturer 106 and commissioned by the manufacturer 106 without departing from the scope of the claims. As used herein, manufacturer 106 includes a programmer 134 for initializing or commissioning devices (i.e., device 102). Programmer 134 may include a field programmable gate array programmer, a USB host and connector, a Bluetooth low energy communications module, or some other communications system for connecting to the device 102 for commissioning. As used herein, commissioning a device 102 includes providing the device 102 with at least a major and a minor. Commissioning may also include providing device 102 with a set of computer executable instructions stored in the device 102 memory 110 to cause the device 102 to operate as described herein, including one or more appropriate Unique User Identification (UUID) as further described herein. Alternatively, the device 102 memory 110 may be hardwired with programming or executable instructions (or a subset thereof) while being physically formed. It is further contemplated that components of the manufacturer 106 may be distributed in vastly different geographic areas while not departing from the scope of the claims.

Communicating Device Status Via Bluetooth Low Energy without Connecting to a Device

As discussed above, the iBeacon advertising protocol does not allow for a data payload, only an identifier payload of a specified length (i.e., a 128 bit UUID, a 16 bit major, and a 16 bit minor) in messages broadcast by iBeacons (i.e., iBeacon devices). Aspects of the invention provide a way to convey information about the state of device 102 or enable configuration of the device 102 without the use of features in the standard Bluetooth protocol implementing an “always on” connection (which drains device batteries) and a payload data field. Aspects of the invention notify the manager 104 associated with the device 102 when the device 102 is in some kind of stress, fault, or out-of-nominal condition without maintaining a dedicated connection to the device 102.

In one embodiment, the device 102 is configured to broadcast three different UUIDs or messages:

Standard—UUID 1 (message approximately every 900 ms)

Out of nominal—UUID 2 (message approximately every 1800 ms)

Battery Alarm—UUID 3 (message approximately every 1800 ms)

If there is no out-of-nominal issues (for example, sensor is not indicting a problem or battery is not below a threshold), then the device 102 broadcasts a first message using the first UUID, UUID1. If a sensor of the device 102 detects an issue, the device 102 will broadcast a different UUID (i.e., second UUID, UUID2, or third UUID, UUID3) periodically to communicate this change to the associated manager 104.

For any particular device, the major and minor numbers are unique to that device. The major and minor do not change in any broadcast message emanating from the device. The UUIDs that are used in the broadcast change based on conditions, but the uniqueness of the device is maintained through keeping the major and minor the same.

One way to think of the use of the second UUID, UUID2, and third UUID, UUID3, is as a secondary signaling mechanism deployed to tell the user a little more about the device than a prior art iBeacon compatible device can without connecting to the manager or violating the iBeacon advertising protocol.

For example, if a button on the device 102 is pressed, the device 102 will broadcast a second message using the second UUID, UUID2, the major, and the minor which will be received by the manager 104 (e.g., a user's smartphone or tablet). This will indicate to the manager 104 that some action needs to be taken—for example, ringing the phone 104 to alert the user to the button press. This signaling mechanism allows the manager 104 to get notifications and conditional information from the device 102 without having to be connected to the device all the which significantly shortens battery life of both the device 102 and the manager 104.

Thus, instead of continuously polling the device 102, the system 100 is proactive in causing the device 102 to communicate information to managers in range of the device 102 (i.e., receiving the messages broadcast by the device 102).

In one embodiment, the system 100 includes an iBeacon compatible Bluetooth low energy device 102, and an iBeacon compatible Bluetooth low energy device manager 104. The device 102 is configured to periodically broadcast a message consisting of a UUID, a major, and a minor. The manager 104 is configured to receive the broadcast message from the device 102. The device is further configured to periodically broadcast a first message consisting of a first UUID, the major, and the minor or a second message consisting of a second UUID, the major, and the minor as a function of a parameter determined by the device 102. The first UUID is different than the second UUID.

In one embodiment, the device 102 is physically associated with an object. That is, the device 102 is physically attached to or integrated with the object. The device manager 104 is configured to determine proximity of the object to the device manager 104 as a function of the received message from the device 102. In one embodiment, the device 102 monitors a characteristic of the object via a sensor 116 of the device 102. The device 102 determines the parameter as a function of the monitored characteristic of the object. The device manager 104 determines the parameter in response to and as a function of receiving the first UUID or the second UUID. The device manager 104 further determines the object to which the determined parameter corresponds as a function of the received major and minor. That is, when the device 102 is placed in service (i.e., paired associated or registered with the manager 104), the manager 104 stores the major and minor of the device 102 in the memory 118 of the manager 104 together with a description of the object. The description may include images, text, or variations thereof.

In one embodiment, the device 102 includes a battery 150. The device 102 is configured to broadcast the first message consisting of the first UUID, the major, and the minor when the device 102 is normal and the monitored characteristic of the object is in a first state. In one embodiment, the device 102 broadcasts the first message consisting of the first UUID, the major, and the minor when the battery 150 has a charge above a predetermined threshold and the monitored characteristic of the object is in the first state. The device 102 is further configured to broadcast the second message consisting of the second UUID, the major, and the minor when the device 102 is in a normal condition and the monitored characteristic of the object is in a second state. In one embodiment, the device 102 broadcasts the second message consisting of the second UUID, the major, and the minor when the battery 150 has a charge above the predetermined threshold and the monitored characteristic of the object is in a second state. The device 102 is also further configured to broadcast a third message consisting of a third UUID, the major, and the minor when the device 102 is in and out of nominal condition and the monitored characteristic of the object is in the first state. In one embodiment, the device broadcasts the third message consisting of the third UUID, the major, and the minor when the battery 150 has a charge below the predetermined threshold and the monitored characteristic of the object is in the second state. The third UUID is different from the first UUID and the second UUID. The device manager 104 is configured to determine the first state of the object in response to receiving the first message. The device manager 104 is further configured to determine the second state of the object in response to receiving the second message. In response to receiving the third message from the device 102, the device manager 104 is configured to identify the object with which the device 102 is associated to a user of the device 102 and device manager 104.

In one embodiment, the device 102 is configured to repeatedly broadcast the first message at a first time interval or first period. The device 102 is further configured to repeatedly broadcast the second message at a second time interval or second period. The first time interval or period is different from the second time interval or period. In one embodiment, the first time interval or first period is 900 ms and the second time interval or second period is 1800 ms. In one embodiment, the device 102 is configured to repeatedly broadcast the third message indicative of a low battery condition (i.e., the charge of the battery 150 is below the predetermined threshold) at a third time interval or third period which is 30 seconds. In this embodiment, the second time interval is longer than the first time interval (i.e., double the first time interval), and the third time interval is longer than the second time interval. In another embodiment, the device 102 is configured to repeatedly broadcast the third message at the second time interval or second period.

Secure Communications Between Device and Associated Manager

Tethering or connecting the manager 104 to the device 102 may provide an easy mechanism to implement security, but it will not scale because there are limitations in the Bluetooth protocols to how many devices you can have connected to the manager 104 tethered to a smartphone or tablet at any one time.

Aspects of the inventions provide a secure yet always open channel to communicate between the manager 104 and devices associated with or registered to the manager 104 in order to in order to configure the devices or to take a specific action (e.g., sounding a buzzer on the device, changing a setting of the device, etc.). Aspects of the invention further prevent a situation where someone could “hack” into the device 102 and, for example, force the buzzer to go off, thereby draining the battery 150 in the device 102.

In one embodiment, a security protocol involves three pieces of information that are used to securely communicate between the device 102 and the manager 104. The 3 pieces of information are a transaction identifier, and encryption key, and a device identifier.

In one embodiment, the transaction identifier is an integer number with a range of <x> to <y>. The transaction identifier is seeded into the device 102 at manufacturing by the manufacturer 106. The transaction identifier changes on every command executed by the device 102. The device 102 can change the transaction identifier to another random/sequential number upon each executed command. The transaction identifier a public value which any iBeacon compatible Bluetooth receiver can read from the device 102 by sending poll request to the device 102 and reading the response from the device 102. In one embodiment, the transaction identifier is a base 64 encoded value of the integer number in the range of <x> to <y>.

In one embodiment, the device identifier is an integer number with a range of <x> to <y>. The device identifier is seeded into the device 102 at commissioning by the manufacturer 106. In one embodiment, the device identifier is the major and the minor which is public. In another embodiment, the device identifier is a private number and is provided to the manager 104 by the manufacturer 106 when the device 102 is registered to the manager 104.

In one embodiment, the encryption key is a private and unique to each device. In one embodiment, the encryption key is an AES 128-bit key. In another embodiment, the encryption key is only 8 bits bytes or 64 bits. The encryption key is a shared, symmetric key. That is both the manager 104 and the device 102 know the encryption key. The manufacturer 104 provides the encryption key to the device 102 at commissioning, and provides the encryption key to the manager 104 when the device 102 is registered with or associated with the manager 104 during setup.

In operation, the secure communications channel between the device 104 and the associated or registered manager 104 begins with the manager 104 polling the device 102 for the transaction identifier. The device 102 responds with the current transaction identifier stored in the memory 110. The manager 104 inserts the transaction identifier into a command string including the device identifier and a command. The manager 104 then uses the encryption key for the device 102 to encrypt the entire message (i.e. container of the message) including the command string and sends the encrypted message to the device 102 via the Bluetooth module 125 of the manager 104. Upon receipt of the encrypted message, the device 102 decrypts the message with the encryption key stored in the memory 110. The device 102 then determines whether the device identifier in the command string matches the device identifier stored in the memory 110 of the device 102 and whether the transaction identifier in the command string matches the transaction identifier stored in the memory 110 of the device 102. If the device identifier and transaction identifier match, the device 102 executes the command in the command string

Generally, this secure communication scheme may be described as a “one-time use” communication protocol to communicate securely with the device 102. For example, if a hacker were able to capture a message broadcast from the device 102 and decrypt it, the hacker could not simply turn around and send that command to the device. The hacker would need to know how to poll the device, receive the current transaction identifier, and also need to figure out the device identifier.

In one embodiment, if there is an invalid command or someone is trying to “hack” the device 102, the device 102 goes into a “sleep” mode for a predetermined period of time (e.g., 30 seconds or more) to prevent constantly responding to bad polls or commands which will drain the battery and dramatically extend the amount of time required to determine the encryption key for even a single device. This significantly reduces the “attack surface” of the device 102. The device 102 continues to broadcast messages during this time, but will not accept any new commands or respond to polling for the transaction identifier (i.e., poll requests).

In one embodiment, a system 100 includes an iBeacon compatible Bluetooth low energy device 102, an iBeacon compatible Bluetooth low energy device manufacturer 106, and an iBeacon compatible Bluetooth low energy device manager 104. The iBeacon compatible Bluetooth low energy device 102 is configured to store a device identifier, a transaction identifier, and an encryption key. The device 102 is further configured to respond to a poll (e.g., poll request) by transmitting the transaction identifier. The manufacturer 106 is configured to provide the device 102 with the device identifier, the transaction identifier, and the encryption key.

The manager 104 is configured to poll the device 102 for the transaction identifier stored in the memory 110 of the device 102. The manager 104 receives the transaction identifier transmitted by the device 102 in response to polling. The manager 104 receives the encryption key for the device 102 from the manufacturer 106 when the device 102 is associated with or registered to the manager 104. The manager 104 generates a command string including the device identifier stored in the manager 104 for the device 102, the transaction identifier received from the device 102, and a command. The manager 104 encrypts the command string as a function of the encryption key received from the manufacturer 106 to generate to generate an encrypted command. In one embodiment, the device 102 provides the encryption key to the manager 104 when the device 102 is registered to or associated with the manager 104. The manager 104 transmits the encrypted command to the device 102. The device 102 receives the encrypted command transmitted by the manager 104, decrypts the received encrypted command to determine the command string. The device 102 verifies that the device identifier and transaction identifier in the determined command string match the device identifier in transaction identifier stored in the memory 110 of the device 102. Device 102 executes the command in the determined command string when the device identifier and transaction identifier in the determined command string match the device identifier in transaction identifier stored in the device 102. In one embodiment, the device identifier consists of a UUID, major, and minor. In another embodiment, the device identifier includes the UUID, major, minor, and a unique number assigned to the device 102 by the manufacturer 106. In yet another embodiment, the device identifier includes only the major and the minor. In one embodiment, the device 102 is configured to increment the transaction identifier in response to executing the command. Incrementing the transaction identifier may be moving to the next sequential transaction identifier or randomly generating a new transaction identifier. In one embodiment, polling the device 102 includes transmitting the device identifier to the device 102. In one embodiment, the device 102 is configured to determine whether the command in the determined command string is a valid command and ignore polling for a predetermined period of time in response to determining that the determined command string is not a valid command. In one embodiment, the predetermined period of time during which the device 102 ignores polling is 30 seconds. In one embodiment, the device 102 continues periodically broadcasting message consisting of a UUID, a major, and a minor of the device 102 while ignoring polling during the predetermined period of time. In one embodiment, the command changes the encryption key stored in the memory 110 of the device 102 from the current encryption key to a new encryption key. The manager 104 updates the manufacturer 106 with the new encryption key. Alternatively, the new encryption key may be pushed from the manufacturer 106 to the manager 104 such that the manager 104 does not need to update the manufacturer 106 with the new encryption key.

Safe Zones, Temporary Zones, Enhanced Battery Management

The general concept here is that the manager 104 recognizes patterns in a user's location and adapts the behavior of the manager 104 and device 102 based on these patterns. The two main changes in system 100 behavior based on pattern recognition involve notification suppression and battery management.

In the manager 104, safe zones are areas that the user of the manager 104 creates where the manager 104 can lose a connection to associated devices (i.e., device 102) and a notification is not sent to the user (e.g., provided to the user via a user interface 126 of the manager 104). This prevents repeated notifications for objects that the user may temporarily lose connection to while in a “well known” area such as the user's home, office, etc.

For an enterprise solution, a safe zone could be the location of a warehouse and could be used to track available inventory by enumerating the devices within the zone. Assuming that each device is attached to a deployable business asset, an asset whose location is outside this safe zone would be considered a deployed business asset and could trigger additional business logic within the enterprise solution. In one embodiment, safe zones are characterized by a latitude and longitude coordinate (i.e., GPS coordinates) and a radius to define its location and size. There are no specific restraints on location and size, but in one embodiment, the safe zone radius is approximately 300 meters. In another embodiment, a safe zone is substantially a 4 sided polygon defined by a set of 4 GPS coordinates.

In operation, if a user has their home configured as a safe zone and the device 102 is in the user's handbag, then when the user initially arrives at home, the application recognizes that the handbag, device 102, and the manager 104 (e.g., the user's phone) are both in the safe zone and the manager 104 can hear the handbag device 102 (see i.e., receive messages from the device 102). When the user walks outside of their home with their phone 104 but leaves their handbag inside, if the user temporarily loses connection to the handbag device 102, the user will not get notified, so long as the user (i.e., the user's phone acting as the manager 104) stays within the safe zone. Once the user gets outside the safe zone (i.e., a location of the user's phone 104 is outside of the safe zone), the manager 104 (e.g., the user's phone) will notify the user that the user has been separated from the user's handbag. In one embodiment, the user can instruct the manager 104 to command the device 102 to emit an audible alarm or buzzer. There is an “AND” condition here in the system logic—if the last known location of the device 102 AND the last known location of the user's phone (i.e., the manager 104) are both in a safe zone, then the manager 1041 not provide a notification to the user via the user interface 126.

In one embodiment, when the manager 104 notices that it is spending a lot of time in a particular location, it will set up a temporary zone. This will reduce the activity that the manager 104 places on the GPS and thus the manager's battery as well as reduce the message transmit frequency or interval of the device 102 to conserve the device's battery 150.

In one embodiment, manager 104 can track the speed at which it is leaving a safe zone to determine how quickly to notify the user via the user interface 126. For example, the manager 104 can tell when the user is walking away from their home (e.g., traveling at 3 mph) versus driving away from their home (e.g., traveling at over 15 mph) and adjust the notification process accordingly.

When a user enters a safe zone with the manager 104 and device 102 in range of one another, the manager 104 will signal to the associated devices within range to change the length of time between broadcasts to conserve battery power (i.e., increases broadcast intervals). In one embodiment, the normal broadcast period for the device 102 is 900 ms. If the user is home (and home is a safe zone) and the user's phone (i.e., the manager 104) is close to the device 102, the manager 104 changes the broadcast period to, for example, 30 seconds. This can significantly extend the battery life, especially if the user spends considerable time in a safe zone (e.g., home or office). The user is not aware of this behavior (i.e., there is no indicator on the manager 104 that lets the user know that they have entered into some kind of “low-battery usage state”).

In one embodiment, a system 100 includes an iBeacon compatible Bluetooth low energy device 102 and an iBeacon compatible Bluetooth low energy device manager 104. The device 102 is configured to periodically broadcast a message at a first period. The manager 104 is configured to determine the location of the manager, store a geographic safe zone in the memory 118 of the manager 104, determine whether the manager 104 is in the geographic safe zone as a function of the determined location of the manager 104 and the stored geographic safe zone, and determines that the device 102 is within range of the manager 104 in response to receiving the message periodically broadcast by the device 102. The manager 104 determines that the devices within the geographic safe zone in response to determining that the manager 104 is in the geographic safe zone while the device 102 is determined to be within range of the manager 104. In response to determining that the device 102 and manager 104 are in the geographic safe zone, the manager 104 increases the period of the broadcast message to a second period such that the message is broadcast less frequently. In one embodiment, when the manager 104 determines that the manager 104 and the device 102 are in the geographic safe zone, the manager 104 does not provide a notification to the user of the manager 104 that the device 102 is not in range while the manager 104 remains within the safe zone.

In one embodiment, storing a geographic safe zone includes storing GPS coordinates indicative of the geographic safe zone together with a radius. In one embodiment, determining a location of the manager 104 includes determining GPS coordinates of the manager 104 via a GPS receiver of the manager 104. In one embodiment, determining whether the managers in the geographic safe zone includes comparing the store GPS coordinates indicative of the geographic safe zone to the determine GPS coordinates of the manager 104 and the radius. In one embodiment, the manager 104 includes a plurality of geographic safe zones.

In one embodiment, increasing the period of the broadcast message to the second period such that the broadcast messages broadcast less frequently include sending an encrypted command string to the device indicative of the second period.

In one embodiment, the manager 104 is further configured to determine that the manager 104 has left the geographic safe zone as a function of the determined location of the manager 104. In response to determining that the manager has left the geographic safe zone, the manager 104 decreases the period of the broadcast message to the first period such that the messages broadcast less frequently.

In one embodiment, the manager is further configured to determine a an elapsed time since the manager last received any message from the device 102 and then determine whether the elapsed time exceeds a predetermined threshold. Manager provides a notification to a user of the manager 104 in response to determining that the manager 104 is left the geographic safe zone and the elapsed time exceeds the predetermined threshold. In one embodiment, the manager is further configured to determine the speed of the manager 104 and the predetermined threshold for the elapsed time varies as a function of the determined speed. That is, the higher the speed, the lower the predetermined threshold of the elapsed time.

In one embodiment, the device 102 is further configured to emit an audible alarm in response to receiving alarm command from the manager 104. The manager 104 is configured to receive input from the user of the manager 104 via the user interface 126 to activate the audible alarm of the device 102. The manager 104 provides an encrypted command to the device 102 in response to receiving the input from the user of the manager 104 to activate the audible alarm of the device 102. The provided encrypted command includes the alarm command.

In one embodiment, the manager 104 is further configured to store a temporary zone when the location of the manager 104 remains within a radius of a central point longer than a first threshold with the device 102 in range of the manager 104. The temporary zone is the area within the radius of the central point. In response to determining that the manager 104 is in the temporary zone and that the device is in range, the manager 104 increases the period of the broadcast message to a second period such that the messages broadcast less frequently. In response to determining that the location of the manager 104 is no longer within the temporary zone, the manager 104 erases the temporary zone and decreases the period of the broadcast message to the first period such that the message is broadcast more frequently.

Employing the System to Find a Lost Device

As the population of devices and device managers increases, the system 100 can employ a “network effect” to locate lost or stolen objects (i.e., locate the device affixed to or integrated with the object).

All managers 104 hear all devices 102 within range of the manager, even if the device is not associated with the manager. Therefore, a manager 300 can hear a lost device 102, recognize that the device is known to be lost within the system 100, and inform the manager 104 associated with the device 102 as to the location of the device 102 (and associated object). Users in the system 100 don't have to be explicitly looking for the lost device. The manager 300 acts as a detection point for lost items simply by virtue of listening for messages from iBeacon compatible devices.

In one embodiment, the system 100 includes a lost-and-found reward system. The owner of a lost item can submit a monetary reward via the user interface 126 of the manager 104 used by the owner. Any user who participates in this lost-and-found system would earn a portion of that reward if their manager 300 was part of the detection and locating of the lost item (i.e., their manager 300 reported the location of the lost item to the manufacturer 106 which provided the location to the manager 104 associated with the lost device 102).

In one embodiment, a system 100 includes an iBeacon compatible Bluetooth low energy device 102, a plurality of iBeacon compatible Bluetooth low energy device managers (e.g., 104 and 300), and an iBeacon compatible Bluetooth low energy device manufacturer 106. The device 102 is configured to periodically broadcast a message including a major and a minor unique to that device 102. Each manager of the plurality of managers is configured to receive the broadcast message from the device 102. Device 102 is associated with one manager 104 of the plurality of managers. The manager 104 is configured to determine when the device is lost (e.g., receive input from a user via the user interface 126) and report the lost device 102 by providing the major and minor of the lost device 102 to the manufacturer 106. The manager 106 is configured to receive the report of the lost device 102 from the manager 104 associated with the lost device 102. The manufacturer 106 transmits the major and the minor of the lost device 102 to the plurality of managers. Each manager of the plurality of managers is further configured to receive the message broadcast by the lost device 102 and report a location of the manager 300 together with the major and the minor to the manufacturer 106. The manufacturer 106 is further configured to provide the manager 104 associated with the lost device 102 with the location of the manager 300 reporting the location of the manager 300 together with the major and the minor associated with the lost device 102.

In one embodiment, the lost device 102 is physically associated with an object. That is, the device 102 is attached to or integrated with the object. The manager 104 with which the lost device 102 is associated is further configured to provide an image of the object to the manufacturer 106. The manufacturer 106 is further configured to receive the provided image and provide the image of the object to the manager 300 reporting the location of the manager 300 together with the major and the minor of the lost device 102 in response to receiving the report from the manager 300 reporting the location of the manager 300 together with the major and minor of the lost device 102.

In one embodiment, the manager 104 with which the lost device 102 is associated is further configured to receive a reward amount from a user of the manager 104 and provide the received reward amount to the manufacturer 106. The manufacturer 106 is further configured to receive the provided reward amount and provide the received reward amount to the manager 300 reporting the location of the manager 300 together with the major and minor of the lost device in response to receiving the report from the manager 300 reporting the location of the manager 300 together with the major and minor of the lost device 102. The manufacturer 106 may also provide contact information for the user of the manager 104 associated with a lost device 102 to the manager 300 is found the lost device 102 such that the user of the manager 300 can contact the owner of the lost object and device 102. In this way, the user of the manager 300 finding the lost device 102 can be encouraged to reunite the owner of the object with the object and the lost device 102.

In one embodiment, the system 100 includes managers with no associated devices. These unassociated managers act as buoys deployed solely to report lost devices to the manufacturer 106 and thus the location to the manager 104 associated with the lost device 102.

It will be understood by those of skill in the art that navigating between user interface views is accomplished by selecting a tab or object in a current user interface view corresponding to another user interface view, and in response to selecting the tab or object, the user interface updates with said another user interface view corresponding to the selected tab or object.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful IBEACON COMPATIBLE BLUETOOTH LOW ENERGY DEVICE MONITORING SYSTEM it is not intended that such references be construed as limitations upon the scope of this invention except as set forth in the following claims.

What is claimed is:

1. A system comprising:
an iBeacon compatible Bluetooth low energy device configured to periodically broadcast a message at a first period; and
an iBeacon compatible Bluetooth low energy device manager configured to:
determine a location of the manager;
store a geographic safe zone;
determine whether the manager is in the geographic safe zone as a function of the determined location of the manager and the stored geographic safe zone;
determine that the device is within range of the manager in response to receiving the message periodically broadcast by the device;
determine that the device is within the geographic safe zone in response to determining that the manager is in the geographic safe zone while the device is determined to be within range of the manager; and
in response to determining that the device and manager are in the geographic safe zone, increasing the period of the broadcast message to a second period such that the message is broadcast less frequently.

2. The system of claim 1, wherein:
storing a geographic safe zone comprises storing Global Positioning System (GPS) coordinates indicative of the geographic safe zone together with a radius;
determining a location of the manager comprises determining GPS coordinates of the manager via a GPS receiver of the manager; and
determining whether the manager is in the geographic safe zone comprises comparing the stored GPS coordinates indicative of the geographic safe zone to the determined GPS coordinates of the manager and the radius.

3. The system of claim 1, wherein increasing the period of the broadcast message to the second period such that the message is broadcast less frequently comprises sending an encrypted command string to the device indicative of the second period.

4. The system of claim 1, wherein:
the manager is further configured to determine that the manager has left the geographic safe zone as a function of the determined location of the manager; and
decrease the period of the broadcast message to the first period such that the message is broadcast more frequently.

5. The system of claim 1, wherein:
the manager is further configured to determine that the manager has left the geographic safe zone as a function of the determined location of the manager;
the manager is further configured to determine an elapsed time since the manager last received any message from the device and whether the elapsed time exceeds a predetermined threshold; and
the manager is further configured to provide a notification to a user of the manager in response to determining that the manager has left the geographic safe zone and the elapsed time since the manager last received any message from the device exceeds the predetermined threshold.

6. The system of claim 1, wherein:
the manager is further configured to determine that the manager has left the geographic safe zone as a function of the determined location of the manager;
the manager is further configured to determine an elapsed time since the manager last received any message from the device and whether the elapsed time exceeds a predetermined threshold;
the manager is further configured to provide a notification to a user of the manager in response to determining that the manager has left the geographic safe zone and the elapsed time since the manager last received any message from the device exceeds the predetermined threshold;
the manager is further configured to determine a speed of the manager; and
the predetermined threshold for the elapsed time varies as a function of the determined speed and decreases with the determined speed.

7. The system of claim 1, wherein the geographic safe zone is one of a plurality of geographic safe zones stored in the manager.

8. The system of claim 1, wherein when the manager determines that the manager and the device are in the geographic safe zone, the manager does not provide a notification to a user of the manager that the device is not in range while the manager remains in the safe zone.

9. The system of claim 1, wherein:
the device is further configured to emit an audible alarm in response to receiving an alarm command from the manager;
the manager is configured to receive input from a user of the manager to activate the audible alarm of the device; and
the manager is further configured provide a command string to the device in response to receiving input from the user of the manager to activate the audible alarm of the device, wherein the provided command string comprises the alarm command.

10. The system of claim 1, wherein:
the manager is further configured to store a temporary zone when the location of the manager remains within a radius of a central point longer than a first threshold with the device in range of the manager, said temporary zone being the area within the radius of the central point; and
in response to determining that the manager is in the temporary zone and the device is in range, increasing the period of the broadcast message to a second period such that the message is broadcast less frequently.

11. The system of claim 1, wherein the manager is further configured to:
store a temporary zone when the location of the manager remains within a radius of a central point longer than a first threshold with the device in range of the manager, said temporary zone being the area within the radius of the central point;
determine whether the location of the manager is in the temporary zone;
in response to determining that the location of the manager is in the temporary zone and the device is in range, increasing the period of the broadcast message to a second period such that the message is broadcast less frequently;
in response to determining that the location of the manager is no longer in the temporary zone, erasing the temporary zone and decreasing the period of the broadcast message to the first period such that the message is broadcast more frequently.

12. A system comprising:
an iBeacon compatible Bluetooth low energy device configured to periodically broadcast a message at a first period; and
an iBeacon compatible Bluetooth low energy device manager configured to:
determine a location of the manager;
determine that the device is within range of the manager in response to receiving the message periodically broadcast by the device;
store a temporary zone when the location of the manager remains within a radius of a central point longer than a first threshold with the device in range of the manager, said temporary zone being the area within the radius of the central point;
determining whether the location of the manager is in the temporary zone; and
in response to determining that the location of the manager is in the temporary zone and the device is in range, increasing the period of the broadcast message to a second period such that the message is broadcast less frequently.

13. The system of claim 12, wherein the manager is further configured to:
in response to determining that the location of the manager is no longer in the temporary zone, erasing the temporary zone and decreasing the period of the broadcast message to the first period such that the message is broadcast more frequently.

14. The system of claim 12, wherein the manager is further configured to:
store a geographic safe zone;
determine whether the manager is in the geographic safe zone as a function of the determined location of the manager and the geographic safe zone;
determine that the device is within the geographic safe zone in response to determining that the manager is in the geographic safe zone while the device is determined to be within range of the manager; and
in response to determining that the device and manager are in the geographic safe zone, increasing the period of the broadcast message to a second period such that the message is broadcast less frequently.

15. A system comprising:
an iBeacon compatible Bluetooth low energy device configured to periodically broadcast a message comprising a major and a minor;
a plurality of iBeacon compatible Bluetooth low energy device managers, each configured to receive the broadcast message from the device, wherein:
the device is associated with one manager of the plurality of managers; and
the manager is configured to determine when the device is lost and report the lost device by providing the major and the minor of the lost device;
an iBeacon compatible Bluetooth low energy device manufacturer configured to:
receive the report of the lost device from the manager associated with the lost device; and
transmit the major and the minor of the lost device to the plurality of managers;
wherein each manager of the plurality of managers is further configured to receive the message broadcast by the lost device and report a location of the manager together with the major and the minor to the manufacturer; and
the manufacturer is further configured to provide the manager associated with the lost device with the location of the manager reporting the location of the manager together with the major and the minor associated with the lost device.

16. The system of claim 15, wherein:
the lost device is physically associated with an object;
the manager with which the lost device is associated is further configured to provide an image of the object to the manufacturer;
the manufacturer is further configured to receive the provided image and provide the image of the object to the manager reporting the location of the manager together with the major and the minor of the lost device in response to receiving the report from the manager reporting the location of the manager together with the major and the minor of the lost device.

17. The system of claim 15, wherein:
the manager with which the lost device is associated is further configured to receive a reward amount from a user thereof and provide the received reward amount to the manufacturer; and
the manufacturer is further configured to receive the provided reward amount and provide the received award amount to the manager reporting the location of the manager together with the major and the minor of the lost device in response to receiving the report from the manager reporting the location of the manager together with the major and the minor of the lost device.
